(19) United States
(12) Patent Application Publication
(10) Pub. No.: US 2024/0127381 A1
(43) Pub. Date: Apr. 18, 2024

(54) MACHINE-LEARNING BASED TECHNIQUES FOR PREDICTING TRADEMARK SIMILARITY

(71) Applicant: Camelot UK Bidco Limited, London (GB)

(72) Inventors: Evrard van Zuylen, Brussels (BE); Jean-Pierre Cuvelliez, Uccle (BE); Christina Papagiannopoulou, Brussel (BE); David Marques, Alcochete (PT); Jan Waerniers, Aalter (BE); Peter Keyngnaert, Deinze (BE)

(21) Appl. No.: 18/046,394

(22) Filed: Oct. 13, 2022

(51) Int. Cl. G06Q 50/18

(52) U.S. Cl. CPC G06Q 50/184

(57) ABSTRACT

Machine learning-based techniques for predicting trademark similarity are described. For instance, a first trademark pair comprising an attribute of a first trademark and a corresponding attribute of a second trademark is received. A level of similarity is determined between the first trademark pair and respective second trademark pairs included in respective legal proceedings maintained in a database. A subset of proceedings from the proceedings is selected, each proceeding of the subset including a respective second trademark pair that has the level of similarity with the first trademark pair. A feature vector is generated based on each proceeding of the subset. The feature vector is provided to a machine learning model that outputs a prediction score, based on the feature vector, as to whether a subsequent proceeding would find a likelihood of confusion between the first trademark and the second trademark. The prediction score is provided to a user interface.

### BACKGROUND

A trademark serves to indicate the source of goods or services. A trademark may comprise words and/or designs used in connection with the sale of goods or services. In order to be registered, a trademark must avoid likelihood of confusion with any previously-registered trademarks.

A user may wish to assess whether a particular trademark is likely to be determined to be similar to another trademark by an administrative agency or judicial body. For example, the user may wish to make such an assessment to help determine if an application to register the particular trademark will be accepted or refused in view of the other trademark. The user may also wish to make such an assessment to help determine if filing an opposition to the registration of the particular trademark based on the other trademark will succeed or fail. Still further, the user may wish to make such an assessment to help determine if use of the particular trademark will be determined to be infringing or non-infringing with respect to the use of the other trademark.

One method for making such an assessment involves manually searching for published legal proceedings (e.g., administrative agency decisions and/or judicial decisions) to find cases in which a trademark pair being adjudicated is similar to the trademark pair being investigated, reading the text of those proceedings to see what the outcome was in each case, and then trying to infer from the outcomes of the proceedings what the likely outcome would be for the trademark pair being investigated. Such an undertaking can be extremely laborious and time-consuming. Furthermore, the results of such an undertaking can be unreliable as relevant published legal proceedings may be missed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums are described for machine learning-based techniques for predicting trademark similarity. For instance, a first trademark pair comprising an attribute of a first trademark and a corresponding attribute of a second trademark is received. A level of similarity is determined between the first trademark pair and respective second trademark pairs included in respective legal proceedings maintained in a database, each of the respective legal proceedings pertaining to whether a likelihood of confusion exists between its respective second trademark pair. A subset of legal proceedings from the legal proceedings stored in the database is selected, each legal proceeding of the subset including at least one respective second trademark pair that has the level of similarity with the first trademark pair that meets a threshold condition. A first feature vector is generated based on each legal proceeding of the subset of legal proceedings. The first feature vector is provided as an input to a machine learning model that outputs a prediction score, based on the first feature vector, as to whether a subsequent legal proceeding would find a likelihood of confusion between the first trademark and the second trademark. The prediction score is provided to a user interface.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts a block diagram of a system for generating a legal proceeding outcome prediction with respect to a similarity between different trademarks in accordance with an example embodiment.

FIG. 2 depicts a block diagram of a system for generating a legal proceeding outcome prediction with respect to a similarity between different trademarks in accordance with another example embodiment.

FIG. 3 shows a flowchart of a method for generating a prediction as to whether a likelihood of confusion exists between a trademark pair in accordance with an example embodiment.

FIG. 4 shows a flowchart of a method for determining a level of similarity between trademark pairs in accordance with an example embodiment.

FIG. 5 depicts a block diagram of a system for determining a level of similarity between trademark pairs in accordance with an example embodiment.

FIG. 6 shows a flowchart of a method for training a machine learning algorithm in accordance with an example embodiment.

FIG. 7 shows a block diagram of a system for training a machine learning model in accordance with an example embodiment.

FIG. 8 shows a block diagram of an example computer system in which embodiments may be implemented.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

The embodiments described, herein, are directed to machine learning-based techniques for predicting trademark similarity. For instance, a first trademark pair comprising an attribute of a first trademark and a corresponding attribute of a second trademark is received. A level of similarity is determined between the first trademark pair and respective second trademark pairs included in respective legal proceedings maintained in a database, each of the respective legal proceedings pertaining to whether a likelihood of confusion exists between its respective second trademark pair. A subset of legal proceedings from the legal proceedings stored in the database is selected, each legal proceeding of the subset including at least one respective second trademark pair that has the level of similarity with the first trademark pair that meets a threshold condition. A first feature vector is generated based on each legal proceeding of the subset of legal proceedings. The first feature vector is provided as an input to a machine learning model that outputs a prediction score, based on the first feature vector, as to whether a subsequent legal proceeding would find a likelihood of confusion between the first trademark and the second trademark. The prediction score is provided to a user interface.

The techniques described, herein, advantageously enable a user to assess the risk of similarity (and therefore, the risk of refusal) if a certain trademark is applied for, assess the potential success of filing an opposition, assess the potential success of a trademark infringement lawsuit, etc. For instance, given two existing trademarks, the techniques described herein identify relevant legal proceedings pertaining to trademarks that are highly similar to the existing trademarks. Based on the decisions or outcomes of the legal proceedings, a prediction is made indicative of the likelihood that an adjudicator would find a likelihood of similarity between the existing trademark pair.

In accordance with the embodiments described herein, the prediction score and the similarity analysis are based on an analysis of vector representations of the legal proceedings (rather than on the actual text of the legal proceedings). Accordingly, the amount of compute resources (e.g., processing cycles, memory storage, power, etc.) required to perform the similarity analysis and prediction score determination according to the embodiments described herein is far less than compared to conventional techniques, in which the analysis is performed on a textual analysis of rather lengthy legal proceedings.

In addition, the prediction score determination is performed utilizing machine learning-based techniques, where a machine learning algorithm is trained utilizing selective legal proceeding training data sets. To form a particular legal proceeding training data set, a legal proceeding pertaining to a first trademark pair is selected from a repository of legal proceedings. A similarity analysis is then performed to determine other legal proceedings in the repository that pertain to respective second trademark pairs having a level of similarity to the first trademark pair. The legal proceedings that are deemed to be the most similar are included as part of the legal proceeding data set. Limiting the amount of legal proceedings utilized to train a machine learning algorithm in this manner (rather than using the entire corpus of legal proceedings) advantageously reduces the processing overhead (e.g., processing cycles, memory, power, etc.) required to train the machine learning algorithm while also improving the quality of the predictions of the resulting machine learning model.

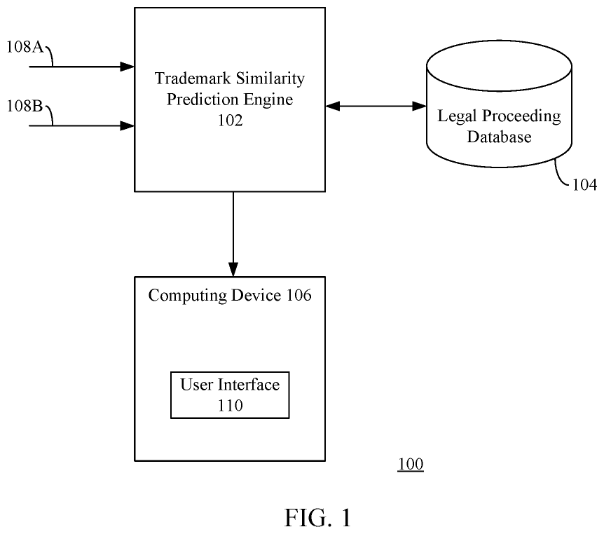

For instance, FIG. 1 shows a block diagram of a system 100 for generating a legal proceeding outcome prediction with respect to a similarity between different trademarks in accordance with an example embodiment. System 100 includes a trademark similarity prediction engine 102, a legal proceeding database 104, and a computing device 106. Legal proceeding database 104 may comprise a plurality of legal proceedings from one or more jurisdictions (e.g., legal proceedings from different states, countries, regions, etc.). Examples of legal proceedings include, but are not limited to, judicial opinions (or legal proceeding) pertaining to whether there is a likelihood of confusion between at least two trademarks (i.e., due to similarities therebetween), trademark opposition proceedings, trademark cancellation proceedings, trademark refusal proceedings, and/or any legal proceeding in which an opinion or decision regarding the similarity between one or more trademark pairs, among others, are included. The opinion or decision may be rendered by an adjudicator, such as, a judge, an administrative board or tribunal, a commission, etc. Computing device 106 may be any type of stationary or mobile computing device, including a mobile computer or any handheld device or mobile computing device (e.g., a Microsoft® Surface® device, a laptop computer, a notebook computer, a tablet computer such as an Apple iPad™, a netbook, etc.), a wearable computing device (e.g., a head-mounted device including smart glasses such as Google® Glass™, etc.), or a stationary computing device such as a desktop computer or PC (personal computer). Trademark similarity prediction engine 102 and/or legal proceeding database 104 may be implemented using one or more server computers or computing devices (not shown), which may include one or more distributed or “cloud-based” servers and/or on-premises server(s), in embodiments.

Each legal proceeding in legal proceeding database 104 may be associated with a confusion score, which is indicative of a likelihood of confusion between trademarks to which the legal proceeding pertains. For instance, the confusion score for a legal proceeding may be based on the adjudicator's opinion or decision as to whether there is a likelihood of confusion between the trademarks to which the legal proceeding pertains. In a particular example, the confusion score may be equal to 1.0 if the opinion or decision indicates that there is a likelihood of confusion between trademarks, and the confusion score may be equal to 0.0 if the opinion or decision indicates that there is not likelihood of confusion between trademarks. It is noted that the confusion score may include other values, for instance, in a scenario in which there is a legal proceeding for particular trademarks in multiple jurisdictions. In this scenario, the confusion score may be collectively based on the decisions for such legal proceedings. For example, suppose a court in a first jurisdiction (e.g., the United States) issued a first judicial opinion that there is a likelihood of confusion between a first trademark (e.g., “BIKE24”) and a second trademark (e.g., “BIKe2”). Individually, the confusion score for this opinion may be 1.0. Further suppose a court in a second jurisdiction (e.g., Europe) issued a second judicial opinion that there is no likelihood of confusion between the first trademark (e.g., “BIKE24”) and the second trademark (e.g., “BIKe2”). Individually, the confusion score for this opinion may be 0.0. The collective confusion score for these opinions, however, may be based on a combination of these scores. In accordance with an embodiment, the collective confusion scores for these opinions are based on an average of the confusion score individually assigned to the opinions (e.g., the collective confusion score for these opinions would be 0.5). Thus, the confusion score assigned to each of these opinions would be 0.5. In accordance with an embodiment, each legal proceeding of legal proceeding database 104 may be assigned an individual confusion score by an analyst that reads the legal proceeding and assigns it a confusion score based on the decision of the legal proceeding. The analyst may also determine the collective confusion score in the event that multiple courts in different jurisdictions ruled on a particular set of trademarks. In accordance with another embodiment, each legal proceeding of legal proceeding database 104 may be automatically assigned an individual confusion score by an automated software application that parses each legal proceeding, determines the decision or opinion, and automatically generates the confusion score based on the decision or opinion. The software application may also automatically determine the collective confusion score in the event that multiple courts in different jurisdictions ruled on a particular set of trademarks.

It is noted that legal proceeding database 104 may not store the entire text for a given legal proceeding. Instead, legal proceeding database 104 may store, for a given legal proceeding, an identifier of the legal proceeding in association with the trademarks to which the legal proceeding pertains, and the confusion score for the legal proceeding.

Trademark similarity prediction engine 102 may be configured to receive a trademark pair comprising a first trademark 108A (and/or attributes thereof) and a second trademark 108B (and/or corresponding attributes thereof). Examples of attributes include one or more of a name of first trademark 108A and second trademark 108B, a design (e.g., a logo) of first trademark 108A and second trademark 108B, a classification of at least one of a good or service of first trademark 108A and second trademark 108B, etc. The trademark pair (and/or respective attributes) may be received from a software application or service that automatically searches for trademarks that are similar to a trademark provided as an input thereto. An example of such a software application or service includes, but is not limited to CompuMark™ published by Clarivate Plc of London, United Kingdom. For instance, the software application or service may be configured to receive, as an input, a trademark. The software application or service may then search for similar trademarks, e.g., via querying a plurality of trademark databases (e.g., from different jurisdictions), searching the Internet for similar trademarks, etc. The application or service may analyze various characteristics of the trademark inputted thereto and/or the searched-for trademarks to determine similarities therebetween. Examples of characteristics include, but are not limited to, the number of characters that are in common between the trademarks, the location of characters within the trademarks, the length of words of the trademarks, etc. The inputted trademark and the trademark(s) (e.g., first trademark 108A and second trademark 108B) determined to be similar to the imputed trademark may be provided to trademark similarity prediction engine 102. Alternatively, first trademark 108A and second trademark 108B may be user-specified, for example, via a user interface (e.g., user interface 110).

Trademark similarity prediction engine 102 may be configured to utilize machine learning-based techniques to analyze legal proceedings and associated confusion scores stored in legal proceeding database 104 and generate a prediction store as to whether an adjudicator of a subsequent legal proceeding would find a likelihood of confusion between first trademark 108A and second trademark 108B. For instance, trademark similarity prediction engine 102 may be configured to analyze legal proceedings to determine a level of similarity between the trademarks (and/or attributes) thereof and the trademark pair (and/or attributes thereof) inputted to trademark similarity prediction engine 102 (e.g., first trademark 108A and second trademark 108B). Trademark similarity prediction engine 102 may be configured to select a subset of legal proceedings from legal proceeding database 104 that includes trademarks (and/or attributes thereof) that have a level of similarity with the inputted trademark pair that meets a threshold condition. For instance, for each legal proceeding in legal proceeding database 104, trademark similarity prediction engine 102 may assign a level of similarity to the legal proceeding based on how similar the trademarks (and/or attributes thereof) to which the legal proceeding pertains are to the inputted trademark pair. The level of similarity may be represented by a similarity value (e.g., ranging between 0.0 and 1.0), where higher the value, the more similar the trademarks (and/or attributes thereof) of a particular legal proceeding are to the trademark pair (and/or attributes thereof) inputted into trademark similarity prediction engine 102. The threshold condition may be the top N (e.g., 50) similarity values, where N is any positive integer. This way, trademark similarity prediction engine 102 may select the legal proceedings including trademarks that are closest in similarity to the inputted trademark pair.

Trademark similarity prediction engine 102 may generate a feature vector based on each of the selected legal proceedings. The generated feature vector is inputted into a machine learning model that outputs a prediction score as to whether a subsequent judicial opinion would find a likelihood of confusion between first trademark 108A and the second trademark 108B. The prediction score may be a value ranging between 0.0 and 1.0, where higher the prediction score, the more likely that an adjudicator of a legal proceeding would find a likelihood of confusion between first trademark 108A and the second trademark 108B. It is noted that the prediction score may be represented in other manners and the values described above are purely for exemplary purposes.

The generated prediction score may be provided to user interface 110 of computing device 106. Additional information may also be presented via user interface 110, including, but not limited to, an identifier (e.g., the parties involved) of each legal proceeding on which the prediction score was based, the jurisdiction(s) of each such legal proceeding, the trademarks for each such legal proceeding, etc. User interface 110 may be a graphical user interface (GUI), although the embodiments described herein are not so limited.

The foregoing techniques advantageously enable a user to assess the risk of similarity (and therefore, the risk of refusal), if a certain trademark is applied for, assess the potential success of filing an opposition, etc. For instance, given two existing trademarks, the techniques described herein identify relevant legal proceedings pertaining to trademarks that are highly similar to the existing trademarks. Based on the decisions or outcomes of the legal proceedings, a prediction is made indicative of the likelihood that an adjudicator would find a likelihood of similarity between the existing trademark pair.

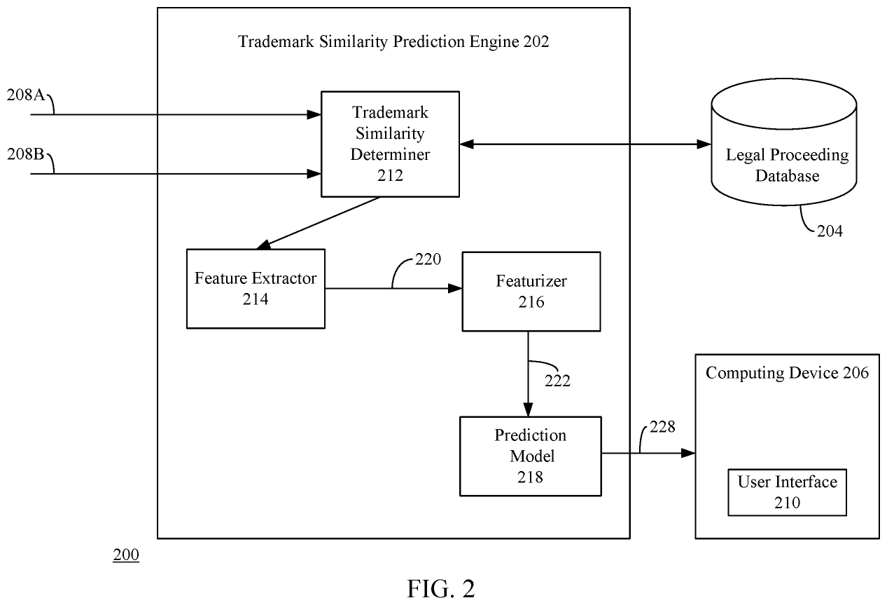

FIG. 2 shows a block diagram of a system 200 for generating a legal proceeding outcome prediction with respect to a similarity between different trademarks in accordance with another example embodiment. As shown in FIG. 2, system 200 comprises a trademark similarity prediction engine 202, a legal proceeding database 204, and a computing device 206. Trademark similarity prediction engine 202, legal proceeding database 204, and computing device 206 are examples of trademark similarity prediction engine 102, legal proceeding database 104, and computing device 106, as respectively described above with reference to FIG. 1. As also shown in FIG. 2, trademark similarity prediction engine 202 comprises a trademark similarity determiner 212, a feature extractor 214, a featurizer 216, and a prediction model 218.

Trademark similarity determiner 212 is configured to receive, as an input, a trademark pair comprising a first trademark 208A (and/or attributes thereof) and a second trademark 208B (and/or corresponding attributes thereof). First trademark 208A and second trademark 208B are examples of first trademark 108A and second trademark 108B, as respectively described above with reference to FIG. 1. Trademark similarity determiner 212 is configured to analyze the legal proceedings to determine legal proceedings (e.g., judicial opinions, trademark proceedings, etc.) that are directed to trademarks (and/or attributes thereof) having a level of similarity with first trademark 208A (and/or attributes thereof) and second trademark 208B (and/or attributes thereof). Trademark similarity determiner 212 may be configured to select a subset of legal proceedings from legal proceeding database 204 that includes trademarks (and/or attributes thereof) that have a level of similarity with the inputted trademark pair (e.g., first trademark 208A (and/or attributes thereof) and second trademark 208B (and/or attributes thereof)) that meets a threshold condition. For instance, for each legal proceeding in legal proceeding database 204, trademark similarity determiner 212 may assign a level of similarity to the legal proceeding based on how similar the trademarks (and/or attributes thereof) to which the legal proceeding pertains are to the inputted trademark pair (and/or attributes thereof). The level of similarity may be represented by a similarity value (e.g., ranging between 0.0 and 1.0), where higher the value, the more similar the trademarks of a particular legal proceeding are to the trademark pair inputted into trademark similarity determiner 212. The threshold condition may be the top N (e.g., 50) similarity values. This way, trademark similarity determiner 212 may select the legal proceedings including trademarks that are closest in similarity to the inputted trademark pair.

In accordance with an embodiment, to determine the level of similarity between the inputted trademark pair and each of the trademark pairs to which the various legal proceedings of legal proceeding database 204 pertains, trademark similarity determiner 212 may generate a feature vector based on features of the inputted trademark pair (e.g., first trademark 208A and second trademark 208B). Such features include, but are not limited to, a Levenshtein distance between first trademark 208A and second trademark 208B, a minimum Levenshtein distance determined between the words of first trademark 208A and the words of second trademark 208B, an average position of words having the minimum Levenshtein distance in first trademark 208A and second trademark 208B, a Levenshtein distance between the double metaphone of first trademark 208A and second trademark 208B, a maximum ratio of characters in the subwords of first trademark 208A and second trademark 208B (in a scenario in which first trademark 208A and/or second trademark 208B comprise at least two subwords), a minimum ratio of characters in the subwords of first trademark 208A and second trademark 208B (in a scenario in which first trademark 208A and/or second trademark 208B comprise at least two subwords), a value indicative of whether a single-word trademark is included in a multi-word trademark (e.g., first trademark 208A is included in second trademark 208B, or vice versa), a number of similar characters at the beginning of first trademark 208A and second trademark 208B, an average number of characters in first trademark 208A and/or second trademark 208B, a number of similar characters at the end of first trademark 208A and/or second trademark 208B, an absolute value of a difference between the number of vowels in second trademark 208B and the number of vowels in first trademark 208A, an absolute value of a difference between the number of consonants in second trademark 208B and the number of consonants in first trademark 208A, an absolute value of a difference between the number of special characters (e.g., “?”, “!”, “′”, “$”, etc.) in second trademark 208B and the number of special characters in first trademark 208A, an absolute value of a difference between the number of hyphen characters in second trademark 208B and the number of hyphen characters in first trademark 208A, an absolute value of a difference between the number of apostrophe characters in second trademark 208B and the number of apostrophe characters in first trademark 208A, an absolute value of a difference between the number of dots (or periods) in second trademark 208B and the number of dots (or periods) in first trademark 208A, a number of similar words at the beginning of first trademark 208A and second trademark 208B, an average number of words in first trademark 208A and second trademark 208B, a number of similar words at the end of first trademark 208A and second trademark 208B, a value indicative of whether first trademark 208A and second trademark 208B are identical, a value indicative of whether first trademark 208 and second trademark 208B are anagrams, a distance between each letter of first trademark 208A and second trademark 208B, a distance between each letter of a double metaphone of each of first trademark 208A and second trademark 208B, a length of the shortest word of first trademark 208A and second trademark 208B, an average syllable count for first trademark 208A and second trademark 208B (where a syllable is the number of times a series of vowels is in each of first trademark 208A and second trademark 208B), an average number of vowels in first trademark 208A and second trademark 208B, an average number of letters in first trademark 208A and second trademark 208B, an average number of digits in first trademark 208A and second trademark 208B, an average number of special characters in first trademark 208A and second trademark 208B, a number of vowels matching (in the same place) in an even place in first trademark 208A and second trademark 208B, a number of vowels matching (in the same place) in an uneven place in first trademark 208A and second trademark 208B, a minimum number of characters between the number of characters in each of first trademark 208A and second trademark 208B, a number of matching consonants matching (in the same place) in an even place in first trademark 208A and second trademark 208B, a number of matching consonants matching (in the same place) in an uneven place in first trademark 208A and second trademark 208B, a number of matching special characters matching (in the same place) in an even place in first trademark 208A and second trademark 208B, a number of matching special characters matching (in the same place) in an uneven place in first trademark 208A and second trademark 208B, a value indicative of whether all the words first trademark 208A are included in second trademark 208B (or vice versa), a value indicative of whether half the words in first trademark 208A are included in second trademark 208B (or vice versa), a value indicative of whether a single word in first trademark 208A is included in second trademark 208B (or vice versa), a value indicative of whether a common word occurs in a first position (in the case of a single-word trademark versus a multi-word trademark), a value indicative of whether a common word occurs in a second position (in the case of a single-word trademark versus a multi-word trademark), a value indicative of whether a common word occurs in another position (in the case of a single-word trademark versus a multi-word trademark), a value indicative of whether a common word occurs in both first trademark 208A and second trademark 208B with one difference in position (for multi-word trademarks), a value indicative of whether a common word occurs in both first trademark 208A and second trademark 208B at the same position (for multi-word trademarks), a value indicative of whether a common word occurs in both first trademark 208A and second trademark 208B at the first position (for multi-word trademarks), a value indicative of whether a common word occurs in both first trademark 208A and second trademark 208B at the second position (for multi-word trademarks), a value indicative of whether a common word occurs in both first trademark 208A and second trademark 208B at a position other than the first or second positions (for multi-word trademarks), a value indicative of whether there is a digit in at least one of first trademark 208A and second trademark 208B, a value indicative of whether there is a digit and other characters in at least one of first trademark 208A and second trademark 208B, a value indicative of whether there is a digit and other characters in both of first trademark 208A and second trademark 208B, a value indicative of whether there are only digits in at least one of first trademark 208A and second trademark 208B, a value indicative of whether at least one first trademark 208A and second trademark 208B starts with a digit, a value indicative of whether at least one first trademark 208A and second trademark 208B ends with a digit, a value indicative of whether at least one first trademark 208A and second trademark 208B comprises a digit between other characters, etc. For trademarks that comprise designs, graphical characteristics (e.g., colors, edges, curves, etc.) of such designs may be utilized as features.

Similarly, for each legal proceeding in legal proceeding database 204, a feature vector is generated based on features of a respective trademark pair to which the legal proceeding pertains. The features for each respective trademark pair may be the same features as described above with reference to first trademark 208A and second trademark 208B. It is noted that for legal proceedings that pertain to more than one trademark pair, a respective feature vector may be generated for each trademark pair to which a particular legal proceeding pertains.

After the feature vectors for first trademark 208A and second trademark 208B and each respective trademark pair from the legal proceedings of legal proceeding database 204 are generated, trademark similarity determiner 212 determines a distance between the feature vector generated for first trademark 208A and second trademark 208B and each feature vector generated for the respective trademark pairs from the legal proceedings of legal proceeding database 204. In accordance with an embodiment, trademark similarity determiner 212 determines a cosine similarity between the feature vector generated for first trademark 208A and second trademark 208B and each feature vector generated for the respective trademark pairs from the legal proceedings of legal proceeding database 204 to determine the distances therebetween. In accordance with another embodiment, trademark similarity determiner 212 determines a mean squared error (also referred to as the sum of squared differences) between the feature vector generated for first trademark 208A and second trademark 208B and each feature vector generated for the respective trademark pairs from the legal proceedings of legal proceeding database 204 to determine the distances therebetween. For instance, suppose the feature vector generated for first trademark 208A and second trademark 208B comprises 55 features (a1, . . . ,a55) and the feature vector generated for a respective trademark pair of a legal proceeding comprises 55 features (b1, . . . ,b55). The distance (or level of similarity) may be calculated as follows:

Distance=(b1−a1)²+(b2−a2)²+ . . . +(b55−a55)² (Equation 1)

It is noted that trademark similarity determiner 212 may utilize other similarity metric-based techniques for determining the distance between vectors and that the techniques described above are purely exemplary.

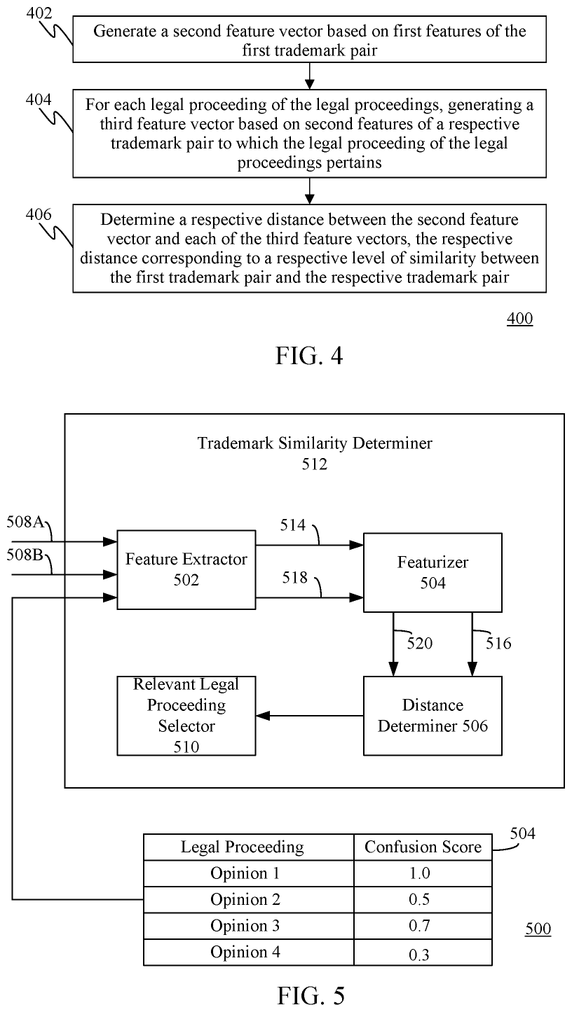

After determining the distances, trademark similarity determiner 212 may rank the distances and select legal proceedings having the top (or closest) N (e.g., 50) distances (or levels of similarity). This way, trademark similarity determiner 212 may select legal proceedings including trademarks that are closest in similarity to the inputted trademark pair (e.g., first trademark 208A and second trademark 208B). Trademark similarity determiner 212 provides the top N legal proceedings to feature extractor 214. Additional details regarding determining the level of similarity are described below with reference to FIGS. 4 and 5.

For each selected legal proceeding including trademarks that are closest in similarity to the inputted trademark pair, feature extractor 214 is configured to extract features associated therewith. For instance, feature extractor 214 may extract a first feature corresponding to the confusion score associated with the trademark pair to which the legal proceeding pertains, a second feature corresponding to the level of similarity between the trademark pair inputted into trademark similarity determiner 212 (i.e., first trademark 208A and second trademark 208B) and the trademark pair to which the legal proceeding pertains, and a third feature corresponding to a similarity metric between the trademarks of the trademark pair to which the legal proceeding pertains. The second feature may be determined by determining a distance between the feature vector generated for first trademark 208A and second trademark 208B (as described above) and each feature vector generated for a respective selected legal proceeding including trademarks that are closest in similarity to the inputted trademark pair (as also described above). The third feature may be determined by calculating a distance between the trademarks of the trademark pair to which the legal proceeding pertains. The distance may be calculated utilizing various techniques, including, but not limited to, a Damerau-Levenshtein distance determination-based algorithm, a Jaro-based similarity determination algorithm, a Jaro-Winkler-based similarity determination algorithm, a cosine similarity-based algorithm that determines the similarity between character bi-grams and tri-grams, a Jaccard-based similarity coefficient determination-based algorithm that determines the similarity between character bi-grams and tri-grams, a Dice-based similarity coefficient determination-based algorithm that determines the similarity between character bi-grams, an adapted Jaccard-based similarity determination-based algorithm that determines the similarity between character skip-grams, etc. Similarity metrics may also be determined for corresponding metaphone and Nysiis phonetic representations of the trademarks. The extracted features (shown as features 220) are provided to featurizer 216.

Featurizer 216 may concatenate the determined first feature (e.g., the confusion score) of each selected legal proceeding into a first feature vector. For example, the first feature vector may store the first features in an accumulated fashion. For instance, suppose the 5 closest legal proceedings (in terms of distance as described above) had the following 5 confusion scores (0.0, 1.0, 1.0, 1.0, 1.0, and 1.0). The first feature of the first feature vector may be 0.0 (i.e., the confusion score of the closest legal proceeding, the second feature of the first feature vector may be the cumulation of the confusion score of next closest legal proceeding (e.g., 1.0) and the confusion score corresponding to the first feature. In this case, the value of the second feature is 1.0 (i.e., 0.0+1.0=1.0). The third feature of the first feature vector may be the cumulation of the confusion score of the next closest legal proceeding (e.g., 1.0) and the confusion score corresponding to the first two features. In this case, the value of the third feature is 2.0 (i.e., 0.0+1.0+1.0=2.0). The fourth feature of the first feature vector may be the cumulation of the confusion score of the next closest legal proceeding (e.g., 1.0) and the confusion score corresponding to the first three features. In this case, the value of the fourth feature is 3.0 (i.e., 0.0+1.0+1.0+1.0=3.0). The fifth feature of the first feature vector may be the cumulation of the confusion score of the next closest legal proceeding (e.g., 1.0) and the confusion score corresponding to the first four features. In this case, the value of the fifth feature is 4.0 (i.e., 0.0+1.0+1.0+1.0+1.0=4.0).

Featurizer 216 may concatenate the determined second feature of each selected legal proceeding (e.g., the distance between the feature vector generated for first trademark 208A and second trademark 208B and each feature vector generated for a respective selected legal proceeding including trademarks that are closest in similarity to the inputted trademark pair) into a second feature vector. For example, in the example in which the 5 closest legal proceedings are selected, suppose that the distances between these legal proceedings and first trademark 208A and second trademark 208B are 0.11, 0.14, 0.21, 0.21, and 0.21). In this case, the second feature vector may be a concatenation of 0.11, 0.14, 0.21, 0.21, and 0.21.

Featurizer 216 may concatenate the determined third feature of each selected legal proceeding (e.g., the similarity metric between the trademarks of the trademark pair to which the legal proceeding pertains) into a third feature vector. For example, in the example in which the 5 closest legal proceedings are selected, suppose that the similarity metric determined for each trademark pair of the selected legal proceedings is 0.89, 0.82, 0.77, 0.99, and 0.33). In this case, the third feature vector may be a concatenation of 0.89, 0.82, 0.77, 0.99, and 0.33.

The determined first feature vector, the determined second feature vector, and the determined third feature vector may be combined (e.g., concatenated) together to generate a combined feature vector 222 (e.g., [0, 1, 2, 3, . . . , 0.11, 0.14, 0.21, . . . , 0.89, 0.82. 0.77, . . . ]). Combined feature vector 222 is provided to prediction model 218.

Prediction model 218 is configured to receive, as an input, combined feature vector 222. Prediction model 218 comprises a machine learning-based prediction model that outputs a prediction score 228 as to whether an adjudicator of subsequent legal proceeding would find a likelihood of confusion between first trademark 208A and second trademark 208B.

In accordance with an embodiment, prediction model 218 is based on a supervised machine learning algorithm that learns whether a particular trademark pair is similar (e.g., whether there is a likelihood of confusion) based on different legal proceedings that comprise rulings or decisions as to whether a likelihood of confusion exists between respective trademark pairs of those legal proceedings.

To train the machine learning algorithm, a feature vector is generated for each legal proceeding stored in legal proceeding database 204. For each legal proceeding, a respective distance between its feature vector and the feature vectors generated for the other legal proceedings is determined. Each of the feature vectors of the other legal proceedings that has a respective distance from the feature vector of the initial legal proceeding that meets a threshold condition is provided as training data to the machine learning algorithm. The threshold condition may be the N closest distances. Thus, the feature vectors of the legal proceedings have the N closest distances to the feature vector of the initial legal proceeding are provided as training data to the machine learning algorithm. Each of the N closest feature vectors may be labeled with the confusion score (as described above) assigned to its corresponding legal proceeding. A first subset of the N closest feature vectors having a confusion score that are in a first range (e.g., 0.00 to 0.49) may be provided as a first training data set (also referred to as negatively-labeled data, as it may represent trademark pairs not having a likelihood of confusion). A second subset of the N closest feature vectors having a confusion score that are in a second range (e.g., 0.50 to 1.00) may be provided as second training data set (also referred to as positively-labeled data, as it may represent trademark pairs having a likelihood of confusion). The foregoing techniques is repeated for each legal proceeding in legal proceeding database 204.

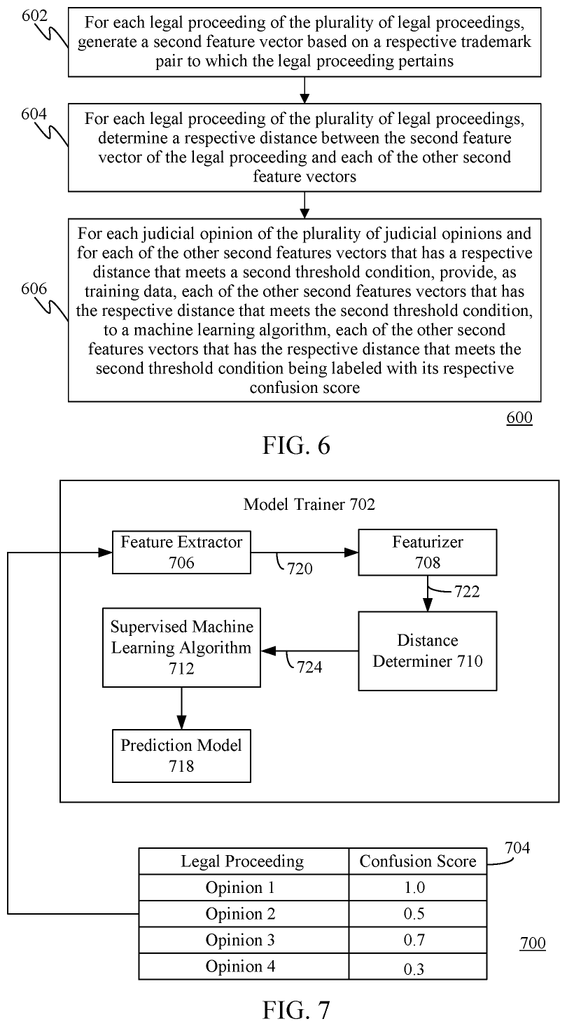

Using these training data sets, the machine learning algorithm learns what constitutes a trademark pair having a likelihood of confusion and generates prediction model 218 that is utilized to generate a prediction score (e.g., prediction score 228) indicative of whether an adjudicator of subsequent legal proceeding would find a likelihood of confusion between first trademark 208A and second trademark 208B. It is noted that using the feature vectors that are closest in distance to the initial feature vector (rather than using feature vectors generated for all the legal proceedings) advantageously reduces the processing overhead (e.g., processing cycles, memory, power, etc.) required to train the machine learning algorithm while also improving the quality of the predictions of the resulting machine learning model. Additional details regarding training a machine learning algorithm to generate prediction model 218 are provided below with reference to FIGS. 6 and 7.

Prediction score 228 may be a value ranging between 0.0 and 1.0, where higher the prediction score, the more likely that a decision of a judicial opinion or proceeding would find a likelihood of confusion between first trademark 208A and second trademark 208B. It is noted that prediction score 228 may be represented in other manners and the values described above are purely for exemplary purposes.

Prediction score 228 may be provided to a user interface 210 of computing device 206. Additional information may also be presented via user interface 210, including, but not limited to, an identifier (e.g., the parties involved) of each legal proceeding on which the prediction score was based, the jurisdiction(s) of each such legal proceeding, the trademarks for each legal proceeding, etc. User interface 210 may be a graphical user interface (GUI), although the embodiments described herein are not so limited. In accordance with an embodiment in which trademark similarity prediction engine 202 is implemented as a web-based service, the web-based service may be accessible via a browser application executing on computing device 206. For instance, a user may navigate to the web-based service utilizing the browser application and input first trademark 208A and second trademark 208B. The web-based service may output prediction model 218 (in accordance with the embodiments described above) via user interface 210, which may be a web page rendered via the browser application. Additional information may also be presented via user interface 210, including, but not limited to, an identifier (e.g., the parties involved) of each legal proceeding on which the prediction score was based, the jurisdiction(s) of each such legal proceeding, the trademarks for each such legal proceeding, etc.

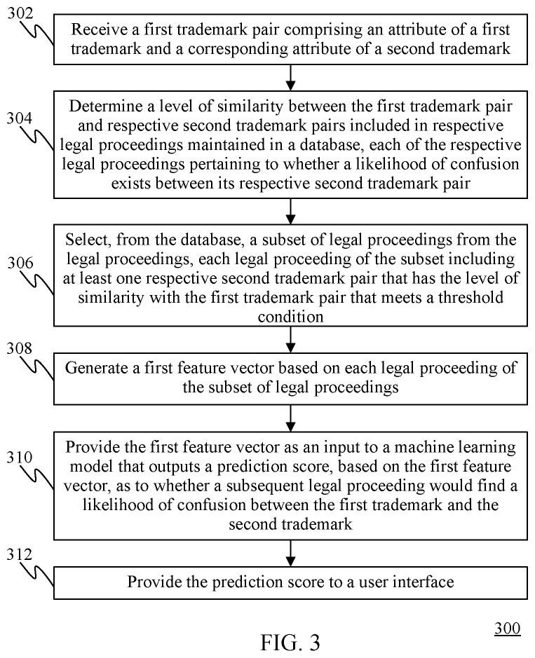

Accordingly, a prediction as to whether a likelihood of confusion exists between a trademark pair may be determined in many ways. For instance, FIG. 3 shows a flowchart 300 of a method for generating a prediction as to whether a likelihood of confusion exists between a trademark pair in accordance with an example embodiment. In an embodiment, flowchart 300 may be implemented by system 200, as described in FIG. 2. Accordingly, flowchart 300 will be described with continued reference to FIG. 2. Other structural and operational embodiments will be apparent to persons skilled in the relevant art(s) based on the following discussion regarding flowchart 300 and system 200.

As shown in FIG. 3, the method of flowchart 300 begins at step 302. At step 202, a first trademark pair comprising an attribute of a first trademark and a corresponding attribute of a second trademark is received. For example, with reference to FIG. 2, trademark similarity determiner 212 receives a first trademark pair comprising an attribute of a first trademark 208A and a corresponding attribute of a second trademark 208B.

In accordance with one or more embodiments, the attribute comprises at least one of a name of the first trademark and the second trademark, a design of the first trademark and the second trademark or a classification of at least one of a good or service of the first trademark and the second trademark. For example, with reference to FIG. 2, the attribute comprises at least one first trademark 208A and second trademark 208B, a design of first trademark 208A and second trademark 208B or a classification of at least one of a good or service of first trademark 208A and second trademark 208B.

At step 304, a level of similarity between the first trademark pair and respective second trademark pairs included in respective legal proceedings maintained in a database is determined. Each of the respective legal proceedings pertain to whether a likelihood of confusion exists between its respective second trademark pair. For example, with reference to FIG. 2, trademark similarity determiner 212 determines a level of similarity between the first trademark pair and respective second trademark pairs included in respective legal proceedings maintained in legal proceeding database 204. Additional details regarding determining a level of similarity are provided below with reference to FIGS. 4 and 5.

At step 306, a subset of legal proceedings from the legal proceedings is selected from the database. Each legal proceeding of the subset includes at least one respective second trademark pair that has the level of similarity with the first trademark pair that meets a threshold condition. For example, with reference to FIG. 2, trademark similarity determiner 212 selects a subset of legal proceedings from the legal proceedings from legal proceeding database 204. Each legal proceeding of the subset includes at least one respective second trademark pair that has the level of similarity with the first trademark pair that meets a threshold condition.

In accordance with one or more embodiments, each legal proceeding of the subset of legal proceedings is associated with a confusion score indicative of a likelihood of confusion between the respective second trademark pair. For example, with reference to FIG. 2, each legal proceeding of the subset of legal proceedings selected by trademark similarity determiner 212 is associated, legal proceeding database 204, with a confusion score indicative of a likelihood of confusion between the respective second trademark pair.

In accordance with one or more embodiments, the first feature vector comprises at least one of, for each legal proceeding of the subset of legal proceedings, a first feature corresponding to the confusion score associated with at least one the respective second trademark pair of the legal proceeding, a second feature corresponding to the level of similarity between the first trademark pair and the respective second trademark pair of the legal proceedings, or a third feature corresponding to a similarity metric between the at least one respective second trademark pair of the legal proceeding. For example, with reference to FIG. 2, feature vector 222 comprises at least one of, for each legal proceeding of the subset of legal proceedings, a first feature corresponding to the confusion score associated with the at least one respective second trademark pair of the legal proceeding, a second feature corresponding to the level of similarity between the first trademark pair (e.g., first trademark 208A and second trademark 208B) and the respective second trademark pair of the legal proceeding, or a third feature corresponding to a similarity metric between the respective second trademark pair of the legal proceeding.

At step 308, a first feature vector based on each legal proceeding of the subset of legal proceedings is generated. For example, with reference to FIG. 2, feature extractor 214 extracts features associated with each of the subset of legal proceedings and provides the features (features 220) to featurizer 216. Featurizer 216 generates combined feature vector 222 based on features 220.

At step 310, the first feature vector is provided as an input to a machine learning model that outputs a prediction score, based on the first feature vector, as to whether a subsequent legal proceeding would find a likelihood of confusion between the first trademark and the second trademark. For example, with reference to FIG. 2, featurizer 216 provides combined feature vector 222 to prediction model 218, which outputs prediction score 228 based on combined feature vector 222. Prediction score 228 represents a prediction as to whether a subsequent legal proceeding would find a likelihood of confusion between first trademark 208A and second trademark 208B. Additional details regarding the machine learning model are provided below with reference to FIGS. 6 and 7.

At step 312, the prediction score is provided to a user interface. For example, with reference to FIG. 2, prediction score 228 is provided to user interface 210.

FIG. 4 shows a flowchart 400 of a method for determining a level of similarity between trademark pairs in accordance with an example embodiment. In an embodiment, flowchart 400 may be implemented by a system 500, as described in FIG. 5. FIG. 5 depicts a block diagram of system 500 for determining a level of similarity between trademark pairs in accordance with an example embodiment. As shown in FIG. 5, system 500 comprises a trademark similarity determiner and a legal proceeding database 504 (which is represented as a database table). Trademark similarity determiner 512 is an example of trademark similarity determiner 212, as shown in FIG. 2. Trademark similarity determiner 512 comprises a feature extractor 502, a featurizer 504, a distance determiner 506, and a relevant legal proceeding selector 510. The database table depicted in FIG. 5 comprises a first column that specifies an identifier of a legal proceeding maintained by legal proceeding database 504 and a second column that stores the confusion score assigned to a respective legal proceeding. Other structural and operational embodiments will be apparent to persons skilled in the relevant art(s) based on the following discussion regarding flowchart 400 and system 500.

As shown in FIG. 4, the method of flowchart 400 begins at step 402. At step 402, a second feature vector is generated based on first features of the first trademark. For example, with reference to FIG. 5, feature extractor 502 receives a first trademark 508A and a second trademark 508B, which are examples of first trademark 208A and second trademark 208B, as described above with reference to FIG. 5. Feature extractor 502 extracts various features from first trademark 508A and first trademark 508B and provides the features (shown as features 514) to featurizer 504. Featurizer 504 generates a feature vector 516 based on features 514. For instance, featurizer 504 may concatenate the feature values of features 514 into feature vector 516.

In accordance with one or more embodiments, the first features comprise at least one of a measure of distance between the first trademark and the second trademark, a number of similar characters in the first trademark and the second trademark, an average number of characters in both the first trademark and the second trademark, a number of similar characters at a predetermined position of the first trademark and the second trademark, a number of consonants in each of the first trademark and the second trademark, a number of vowels in each of the first trademark and the second trademark, a number of special characters in each of the first trademark and the second trademark, an average number of words in each of the first trademark and the second trademark, a number of characters that match between the first trademark and the second trademark, or a value indicative of whether a first portion of the first trademark is included in the second trademark. For example, with reference to FIG. 5, features 514 comprise at least one of a measure of distance between first trademark 508A and second trademark 508B, a number of similar characters in first trademark 508A and second trademark 508B, an average number of characters in both first trademark 508A and second trademark 508B, a number of similar characters at a predetermined position of first trademark 508A and second trademark 508B, a number of consonants in each of first trademark 508A and second trademark 508B, a number of vowels in each of first trademark 508A and second trademark 508B, a number of special characters in each of first trademark 508A and second trademark 508B, an average number of words in each of first trademark 508A and second trademark 508B, a number of characters that match between first trademark 508A and second trademark 508B, or a value indicative of whether a first portion of first trademark 508A is included in second trademark 508B.

At step 404, for each legal proceeding of the legal proceedings, a third feature vector is generated based on second features of a respective trademark pair to which the legal proceeding of the legal proceedings pertains. For example, with reference to FIG. 5, feature extractor 502 each legal proceeding from legal proceeding database 504. Feature extractor 502, for each legal proceeding, extracts various features from a respective trademark pair to which the legal proceeding of the legal proceedings pertains and provides the features (shown as features 518) to featurizer 504. Featurizer 504 generates a feature vector 520 for each legal proceeding based on respective features 518. For instance, for a given legal proceeding, featurizer 504 may concatenate the feature values determined of features 518 into feature vector 520.

In accordance with one or more embodiment, features 518 extracted from each respective second trademark pair comprise at least one of a measure of distance between a first trademark and a second trademark of the respective trademark pair, a number of similar characters in the first trademark and the second trademark of the respective trademark pair, an average number of characters in both the first trademark and the second trademark of the respective trademark pair, a number of similar characters at a predetermined position of the first trademark and the second trademark of the respective trademark pair, a number of consonants in each of the first trademark and the second trademark of the respective trademark pair, a number of vowels in each of the first trademark and the second trademark of the respective trademark pair, a number of special characters in each of the first trademark and the second trademark of the respective trademark pair, an average number of words in each of the first trademark and the second trademark of the respective trademark pair, a number of characters that match between the first trademark and the second trademark of the respective trademark pair, or a value indicative of whether a first portion of the first trademark is included in the second trademark.

At step 406, a respective distance between the second feature vector and each of the third feature vectors is determined. The respective distance corresponds to a respective level of similarity between the first trademark pair and the respective trademark pair. For example, with reference to FIG. 5, distance determiner 506 determines a distance between feature vector 516 and each of feature vectors 520. The determined distances (shown as distances 522) are provided to relevant legal proceeding selector 510. In accordance with step 306 of FIG. 3, relevant legal proceeding selector 510 selects a subset of legal proceedings from legal proceeding database 504 that has a level of similarity (or distance) that meets a threshold condition. For instance, the legal proceedings having the N closest distances to vector 516 may be selected.

In accordance with one or more embodiments, the respective distance between the second feature vector and each of the third feature vectors is based on a similarity metric between the second feature vector and a respective third feature vector of the third feature vectors. For instance, the respective distance may be determined based on a cosine similarity between the second feature vector and a respective third feature vector of the third feature vectors, a mean squared error between the second feature vector and a respective third feature vector of the third feature vectors, etc. For example, with reference to FIG. 5, the respective distance between feature vector 516 and each of feature vectors 520 is based on a similarity metric between feature vector 516 and a respective feature vector 520 of the feature vectors 520. For instance, the respective distance between feature vector 516 and each of feature vectors 520 may be based on a cosine similarity between feature vector 516 and a respective feature vector 520 of feature vectors 520, a mean squared error between feature vector 516 and a respective feature vector 520 of feature vectors 520, etc..

FIG. 6 shows a flowchart 600 of a method for training a machine learning algorithm in accordance with an example embodiment. In an embodiment, flowchart 600 may be implemented by a system 700, as described in FIG. 7. FIG. 7 depicts a block diagram of system 700 for training a machine learning model in accordance with an example embodiment. As shown in FIG. 7, system 700 comprises a model trainer 702 and a legal proceeding database 704 (which is represented by a database table). Legal proceeding database 704 is an example of legal proceeding database 504, as described above with reference to FIG. 5. As shown in FIG. 7, model trainer 702 comprises a feature extractor 706, a featurizer 708, a distance determiner 710, a supervised machine learning algorithm 712, and a prediction model 718. Prediction model 718 is an example of prediction model 218, as described above with reference to FIG. 2. Other structural and operational embodiments will be apparent to persons skilled in the relevant art(s) based on the following discussion regarding flowchart 600 and system 700.

As shown in FIG. 6, the method of flowchart 600 begins at step 602. At step 602, for each legal proceeding of the plurality of legal proceedings, a second feature vector is generated based on a respective trademark pair to which the legal proceeding pertains. For example, with reference to FIG. 7, each legal proceeding maintained by legal proceeding database 704 is provided to feature extractor 706. Feature extractor 706 is configured to extract features associated with each legal proceeding. Examples of such features for a particular legal proceeding include, but are not limited to, a Levenshtein distance between a first trademark and a second trademark of the particular legal proceeding, a minimum Levenshtein distance determined between the words of a first trademark and a second trademark of the particular legal proceeding, an average position of words having the minimum Levenshtein distance in a first trademark and a second trademark of the particular legal proceeding, a Levenshtein distance between the double metaphone of a first trademark and a second trademark of the particular legal proceeding, a maximum ratio of characters in the subwords of a first trademark and a second trademark of the particular legal proceeding (in a scenario in which the first trademark and the second trademark comprise at least two subwords), a minimum ratio of characters in the subwords of a first trademark and a second trademark of the particular legal proceeding (in a scenario in which the first trademark and/or the second trademark comprise at least two subwords), a value indicative of whether a single-word trademark is included in a multi-word trademark (e.g., the first trademark is included in the second trademark, or vice versa), a number of similar characters at the beginning of a first trademark and a second trademark of the particular legal proceeding, an average number of characters in a first trademark and/or a second trademark of the particular legal proceeding, a number of similar characters at the end of a first trademark and/or a second trademark of the particular legal proceeding, an absolute value of a difference between the number of vowels in the second trademark and the number of vowels in first trademark, an absolute value of a difference between the number of consonants in the second trademark and the number of consonants in the first trademark, an absolute value of a difference between the number of special characters (e.g., “?”, “!”, “′”, “$”, etc.) in the second trademark and the number of special characters in the first trademark, an absolute value of a difference between the number of hyphen characters in the second trademark and the number of hyphen characters in the first trademark, an absolute value of a difference between the number of apostrophe characters in the second trademark and the number of apostrophe characters in the first trademark, an absolute value of a difference between the number of dots (or periods) in the second trademark and the number of dots (or periods) in the first trademark, a number of similar words at the beginning of a first trademark and a second trademark of the particular legal proceeding, an average number of words in a first trademark and a second trademark of the particular legal proceeding, a number of similar words at the end of a first trademark and a second trademark of the particular legal proceeding, a value indicative of whether first trademark 208A and second trademark 208B are identical, a value indicative of whether a first trademark and a second trademark of the particular legal proceeding are anagrams, a distance between each letter of a first trademark and a second trademark of the particular legal proceeding, a distance between each letter of a double metaphone of each of a first trademark and a second trademark of the particular legal proceeding, a length of the shortest word of a first trademark and a second trademark of the particular legal proceeding, an average syllable count for a first trademark and a second trademark of the particular legal proceeding (where a syllable is the number of times a series of vowels is in each of the first trademark and the second trademark), an average number of vowels in the first trademark and the second trademark, an average number of letters in a first trademark and a second trademark of the particular legal proceeding, an average number of digits in a first trademark and a second trademark of the particular legal proceeding, an average number of special characters in a first trademark and a second trademark of the particular legal proceeding, a number of vowels matching (in the same place) in an even place in a first trademark and a second trademark of the particular legal proceeding, a number of vowels matching (in the same place) in an uneven place in a first trademark and a second trademark of the particular legal proceeding, a minimum number of characters between the number of characters in each of a first trademark and a second trademark of the particular legal proceeding, a number of matching consonants matching (in the same place) in an even place in a first trademark and a second trademark of the particular legal proceeding, a number of matching consonants matching (in the same place) in an uneven place in a first trademark and a second trademark of the particular legal proceeding, a number of matching special characters matching (in the same place) in an even place in a first trademark and a second trademark of the particular legal proceeding, a number of matching special characters matching (in the same place) in an uneven place in a first trademark and a second trademark of the particular legal proceeding, a value indicative of whether all the words the first trademark are included in the second trademark (or vice versa), a value indicative of whether half the words in the first trademark are included in the second trademark (or vice versa), a value indicative of whether a single word in the first trademark is included in the second trademark (or vice versa), a value indicative of whether a common word occurs in a first position (in the case of a single-word trademark versus a multi-word trademark), a value indicative of whether a common word occurs in a second position (in the case of a single-word trademark versus a multi-word trademark), a value indicative of whether a common word occurs in another position (in the case of a single-word trademark versus a multi-word trademark), a value indicative of whether a common word occurs in both a first trademark and a second trademark of the particular legal proceeding with one difference in position (for multi-word trademarks), a value indicative of whether a common word occurs in both a first trademark and a second trademark of the particular legal proceeding at the same position (for multi-word trademarks), a value indicative of whether a common word occurs in both a first trademark and a second trademark of the particular legal proceeding at the first position (for multi-word trademarks), a value indicative of whether a common word occurs in both a first trademark and a second trademark of the particular legal proceeding at the second position (for multi-word trademarks), a value indicative of whether a common word occurs in both a first trademark and a second trademark of the particular legal proceeding at a position other than the first or second positions (for multi-word trademarks), a value indicative of whether there is a digit in at least one of a first trademark and a second trademark of the particular legal proceeding, a value indicative of whether there is a digit and other characters in at least one of a first trademark and a second trademark of the particular legal proceeding, a value indicative of whether there is a digit and other characters in both of a first trademark and a second trademark of the particular legal proceeding, a value indicative of whether there are only digits in at least one of a first trademark and a second trademark of the particular legal proceeding, a value indicative of whether at least one a first trademark and a second trademark of the particular legal proceeding starts with a digit, a value indicative of whether at least one a first trademark and a second trademark of the particular legal proceeding ends with a digit, a value indicative of whether at least one a first trademark and a second trademark of the particular legal proceeding comprises a digit between other characters, etc.

The determine features (shown as features 720) are provided to featurizer 708. For each legal proceeding, featurizer 708 may concatenate features 720 determined therefor into a respective feature vector 722.

At step 604, for each legal proceeding of the plurality of legal proceedings, a respective distance between the second feature vector of the legal proceeding and each of the other second feature vectors is determined. For example, with reference to FIG. 7, for each legal proceeding, distance determiner 710 determines a respective distance between the feature vector of feature vectors 722 corresponding to the legal proceeding and each of the other feature vectors corresponding to the other legal proceedings.

At step 606, for each legal proceeding of the plurality of legal proceedings, for each of the other second features vectors that has a respective distance that meets a second threshold condition, each of the other second features vectors that has the respective distance that meets the second threshold condition is provided as training data to a machine learning algorithm. Each of the other second features vectors that has the respective distance that meets the second threshold condition is labeled with its respective confusion score. The machine learning algorithm generates the machine learning model based on the training data. For example, with reference to FIG. 7, for each legal proceeding of the plurality of legal proceedings and for each of the other feature vectors corresponding to the other legal proceedings have has a respective distance that meets a threshold condition, distance determiner 710 provides, as training data, each of such other feature vectors to supervised machine learning algorithm 712. The threshold condition may be the closest N distances. Thus, the feature vectors of the legal proceedings having the N closest distances to the feature vector corresponding to the legal proceeding are provided as training data to the machine learning algorithm. Each of the N closest feature vectors may be labeled with the confusion score assigned to its corresponding legal proceeding (as shown in the database table of FIG. 7). A first subset of the N closest feature vectors having a confusion score that are in a first range (e.g., 0.00 to 0.49) may be provided as a first training data set (also referred to as negatively-labeled data, as it may represent trademark pairs not having a likelihood of confusion). A second subset of the N closest feature vectors having a confusion score that are in a second range (e.g., 0.50 to 1.00) may be provided as second training data set (also referred to as positively-labeled data, as it may represent trademark pairs having a likelihood of confusion). The foregoing techniques is repeated for each legal proceeding in legal proceeding database 504. Using these training data sets, supervised machine learning algorithm 712 learns what constitutes a trademark pair having a likelihood of confusion and generates prediction model 718 that is utilized to generate a prediction score (e.g., prediction score 228, as shown in FIG. 2) indicative of whether a subsequent legal proceeding or proceed would find likelihood of confusion between a trademark pair inputted to trademark similarity prediction engine 202 (as shown in FIG. 2).

### III. Example Mobile Device and Computer System Implementation

The systems and methods described above in reference to FIGS. 1-7, trademark similarity prediction engine 102, legal proceeding database 104, computing device 106, user interface 110, trademark similarity prediction engine 202, legal proceeding database 204, computing device 206, user interface 210, trademark similarity determiner 212, feature extractor 214, featurizer 216, prediction model 218, trademark similarity determiner 512, feature extractor 502, featurizer 504, distance determiner 506, relevant legal proceeding selector 510, database 504, model trainer 702, feature extractor 706, featurizer 708, supervised machine learning algorithm 712, distance determiner 710, prediction model 718, and legal proceeding database 704, and/or each of the components described therein, and/or flowcharts 300, 400, and/or 600 may be implemented in hardware, or hardware combined with one or both of software and/or firmware. For example, trademark similarity prediction engine 102, legal proceeding database 104, user interface 110, trademark similarity prediction engine 202, legal proceeding database 204, user interface 210, trademark similarity determiner 212, feature extractor 214, featurizer 216, prediction model 218, trademark similarity determiner 512, feature extractor 502, featurizer 504, distance determiner 506, relevant legal proceeding selector 510, database 504, model trainer 702, feature extractor 706, featurizer 708, supervised machine learning algorithm 712, distance determiner 710, prediction model 718, and legal proceeding database 704, and/or each of the components described therein, and/or flowcharts 300, 400, and/or 600 may be each implemented as computer program code/instructions configured to be executed in one or more processors and stored in a computer readable storage medium. Alternatively, trademark similarity prediction engine 102, legal proceeding database 104, user interface 110, trademark similarity prediction engine 202, legal proceeding database 204, user interface 210, trademark similarity determiner 212, feature extractor 214, featurizer 216, prediction model 218, trademark similarity determiner 512, feature extractor 502, featurizer 504, distance determiner 506, relevant legal proceeding selector 510, database 504, model trainer 702, feature extractor 706, featurizer 708, supervised machine learning algorithm 712, distance determiner 710, prediction model 718, and legal proceeding database 704, and/or each of the components described therein, and/or flowcharts 300, 400, and/or 600 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

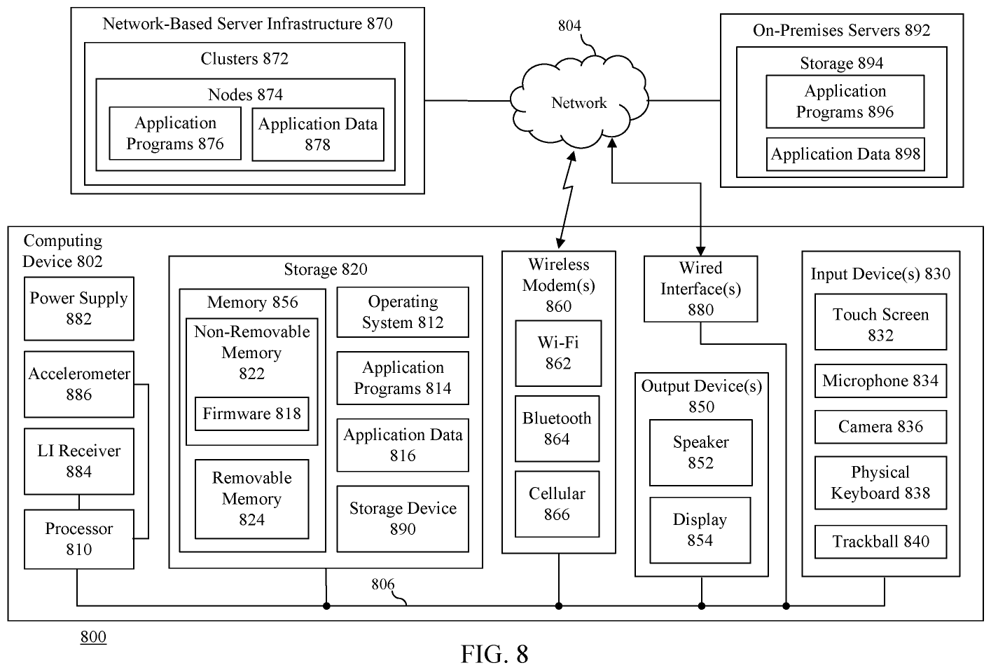

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 8. FIG. 8 shows a block diagram of an exemplary computing environment 800 that includes a computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc., and may include one or more wired and/or wireless portions. Network 804 may additionally or alternatively include a cellular network for cellular communications. Computing device 802 is described in detail as follows.

Computing device 802 can be any of a variety of types of computing devices. For example, computing device 802 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 802 may alternatively be a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, one or more input devices 830, one or more output devices 850, one or more wireless modems 860, one or more wired interface(s) 880, a power supply 882, a location information (LI) receiver 884, and an accelerometer 886. Storage 820 includes memory 856, which includes non-removable memory 822 and removable memory 824, and a storage device 890. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and any combination of the components may be present in a particular embodiment. These components of computing device 802 are described as follows.

A single processor 810 (e.g., central processing unit (CPU), microcontroller, a microprocessor, signal processor, ASIC (application specific integrated circuit), and/or other physical hardware processor circuit) or multiple processors 810 may be present in computing device 802 for performing such tasks as program execution, signal coding, data processing, input/output processing, power control, and/or other functions. Processor 810 may be a single-core or multi-core processor, and each processor core may be single-threaded or multithreaded (to provide multiple threads of execution concurrently). Processor 810 is configured to execute program code stored in a computer readable medium, such as program code of operating system 812 and application programs 814 stored in storage 820. Operating system 812 controls the allocation and usage of the components of computing device 802 and provides support for one or more application programs 814 (also referred to as “applications” or “apps”). Application programs 814 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) that may be present to communicatively couple processor 810 to various other components of computing device 802, although in other embodiments, an alternative bus, further buses, and/or one or more individual signal lines may be present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 890, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 822 may include main memory and may be separate from or fabricated in a same integrated circuit as processor 810. As shown in FIG. 8, non-removable memory 822 stores firmware 818, which may be present to provide low-level control of hardware. Examples of firmware 818 include BIOS (Basic Input/Output System, such as on personal computers) and boot firmware (e.g., on smart phones). Removable memory 824 may be inserted into a receptacle of or otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 890 may be present that are internal and/or external to a housing of computing device 802 and may or may not be removable. Examples of storage device 890 include a hard disk drive, a SSD, a thumb drive (e.g., a USB (Universal Serial Bus) flash drive), or other physical storage device.

One or more programs may be stored in storage 820. Such programs include operating system 812, one or more application programs 814, and other program modules and program data. Examples of such application programs may include, for example, computer program logic (e.g., computer program code/instructions) for implementing one or more of, orchestrator 104, DB host(s) 116, application 118, ledger database 120, ledger database 200, ledger 206, blocks 208-214, key manager 302, data retriever 304, verifier 306, decryptor 308, decryptor 606, application 618, encryptor 802, application 818, nonce generator 1002, encryptor 1010, LAP server(s) 1104, proof requester 1102, proof verifier 1106, location verifier 1132, proof generator 1124, LAP server(s) 1304, proof requester 1302, proof verifier 1306, key generator 1310, location verifier 1332, and/or proof generator 1324, along with any components and/or subcomponents thereof, as well as the flowcharts/flow diagrams (e.g., flowcharts 400, 500, 700, 900, 1200, and/or 1400) described herein, including portions thereof, and/or further examples described herein.

Storage 820 also stores data used and/or generated by operating system 812 and application programs 814 as application data 816. Examples of application data 816 include web pages, text, images, tables, sound files, video data, and other data, which may also be sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 802 through one or more input devices 830 and may receive information from computing device 802 through one or more output devices 850. Input device(s) 830 may include one or more of touch screen 832, microphone 834, camera 836, physical keyboard 838 and/or trackball 840 and output device(s) 850 may include one or more of speaker 852 and display 854. Each of input device(s) 830 and output device(s) 850 may be integral to computing device 802 (e.g., built into a housing of computing device 802) or external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 may display information, as well as operating as touch screen 832 by receiving user commands and/or other information (e.g., by touch, finger gestures, virtual keyboard, etc.) as a user interface. Any number of each type of input device(s) 830 and output device(s) 850 may be present, including multiple microphones 834, multiple cameras 836, multiple speakers 852, and/or multiple displays 854.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). Wireless modem 860 may also or alternatively include other radio-based modem types, such as a Bluetooth modem 864 (also referred to as a “Bluetooth device”) and/or Wi-Fi 862 modem (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and may receive power from a battery internal to computing device 802, and/or from a power cord plugged into a power port of computing device 802 (e.g., a USB port, an A/C power port). LI receiver 884 may be used for location determination of computing device 802 and may include a satellite navigation receiver such as a Global Positioning System (GPS) receiver or may include other type of location determiner configured to determine location of computing device 802 based on received information (e.g., using cell tower triangulation, etc.). Accelerometer 886 may be present to determine an orientation of computing device 802.

Note that the illustrated components of computing device 802 are not required or all-inclusive, and fewer or greater numbers of components may be present as would be recognized by one skilled in the art. For example, computing device 802 may also include one or more of a gyroscope, barometer, proximity sensor, ambient light sensor, digital compass, etc. Processor 810 and memory 856 may be co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein may be stored in storage 820 and executed by processor 810.

In some embodiments, server infrastructure 870 may be present in computing environment 800 and may be communicatively coupled with computing device 802 via network 804. Server infrastructure 870, when present, may be a network-accessible server set (e.g., a cloud-based environment or platform). As shown in FIG. 8, server infrastructure 870 includes clusters 872. Each of clusters 872 may comprise a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. Any of nodes 874 may be a storage node that comprises a plurality of physical storage disks, SSDs, and/or other physical storage devices that are accessible via network 804 and are configured to store data associated with the applications and services managed by nodes 874. For example, as shown in FIG. 8, nodes 874 may store application data 878.

Each of nodes 874 may, as a compute node, comprise one or more server computers, server systems, and/or computing devices. For instance, a node 874 may include one or more of the components of computing device 802 disclosed herein. Each of nodes 874 may be configured to execute one or more software applications (or “applications”) and/or services and/or manage hardware resources (e.g., processors, memory, etc.), which may be utilized by users (e.g., customers) of the network-accessible server set. For example, as shown in FIG. 8, nodes 874 may operate application programs 876. In an implementation, a node of nodes 874 may operate or comprise one or more virtual machines, with each virtual machine emulating a system architecture (e.g., an operating system), in an isolated manner, upon which applications such as application programs 876 may be executed.

In an embodiment, one or more of clusters 872 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 872 may be a datacenter in a distributed collection of datacenters. In embodiments, exemplary computing environment 800 comprises part of a cloud-based platform such as Amazon Web Services® of Amazon Web Services, Inc. or Google Cloud Platform™ of Google LLC, although these are only examples and are not intended to be limiting.

In an embodiment, computing device 802 may access application programs 876 for execution in any manner, such as by a client application and/or a browser at computing device 802. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 802 may additionally and/or alternatively synchronize copies of application programs 814 and/or application data 816 to be stored at network-based server infrastructure 870 as application programs 876 and/or application data 878. For instance, operating system 812 and/or application programs 814 may include a file hosting service client, such as Microsoft® OneDrive® by Microsoft Corporation, Amazon Simple Storage Service (Amazon 53)® by Amazon Web Services, Inc., Dropbox® by Dropbox, Inc., Google Drive™ by Google LLC, etc., configured to synchronize applications and/or data stored in storage 820 at network-based server infrastructure 870.

In some embodiments, on-premises servers 892 may be present in computing environment 800 and may be communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 may be shared by on-premises servers 892 between computing devices of the organization, including computing device 802 (when part of an organization) through a local network of the organization, and/or through further networks accessible to the organization (including the Internet). Furthermore, on-premises servers 892 may serve applications such as application programs 896 to the computing devices of the organization, including computing device 802. Accordingly, on-premises servers 892 may include storage 894 (which includes one or more physical storage devices such as storage disks and/or SSDs) for storage of application programs 896 and application data 898 and may include one or more processors for execution of application programs 896. Still further, computing device 802 may be configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 may be used to implement systems, clients, or devices, or components/subcomponents thereof, disclosed elsewhere herein. In other embodiments, a combination of computing device 802, network-based server infrastructure 870, and/or on-premises servers 892 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 814) may be stored in storage 820. Such computer programs may also be received via wired interface(s) 880 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. CONCLUSION

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined only in accordance with the following claims and their equivalents.

What is claimed is:

1. A method for predicting trademark similarity, comprising:
receiving a first trademark pair comprising an attribute of a first trademark and a corresponding attribute of a second trademark;
determining a level of similarity between the first trademark pair and respective second trademark pairs included in respective legal proceedings maintained in a database, each of the respective legal proceedings pertaining to whether a likelihood of confusion exists between its respective second trademark pair;
selecting, from the database, a subset of legal proceedings from the legal proceedings, each legal proceeding of the subset including at least one respective second trademark pair that has the level of similarity with the first trademark pair that meets a threshold condition;
generating a first feature vector based on each legal proceeding of the subset of legal proceedings;
providing the first feature vector as an input to a machine learning model that outputs a prediction score, based on the first feature vector, as to whether a subsequent legal proceeding would find a likelihood of confusion between the first trademark and the second trademark; and
providing the prediction score to a user interface.

2. The method of claim 1, wherein determining the level of similarity comprises: generating a second feature vector based on first features of the first trademark pair;
for each legal proceeding of the legal proceedings, generating a third feature vector based on second features of a respective trademark pair to which the legal proceeding of the legal proceedings pertains; and
determining a respective distance between the second feature vector and each of the third feature vectors, the respective distance corresponding to a respective level of similarity between the first trademark pair and the respective trademark pair.

3. The method of claim 2, wherein the respective distance between the second feature vector and each of the third feature vectors is based on a similarity metric between the second feature vector and a respective third feature vector of the third feature vectors.

4. The method of claim 1, wherein each legal proceeding of the subset of legal proceedings is associated with at least one confusion score indicative of a likelihood of confusion between the at least one respective second trademark pair.

5. The method of claim 4, wherein the first feature vector comprises at least one of: for each legal proceeding of the subset of legal proceedings:
a first feature corresponding to the confusion score associated with the at least one respective second trademark pair of the legal proceeding;
a second feature corresponding to the level of similarity between the first trademark pair and the respective second trademark pair of the legal proceeding; or
a third feature corresponding to a similarity metric between the at least one respective second trademark pair of the legal proceeding.

6. The method of claim 1, wherein each legal proceeding of the plurality of legal proceedings is associated with at least one confusion score indicative of a likelihood of confusion between the at least one respective second trademark pair, and wherein the machine learning model is generated by:
for each legal proceeding of the plurality of legal proceedings:
generating a second feature vector based on a respective trademark pair to which the legal proceeding pertains;
for each legal proceeding of the plurality of legal proceedings:
determining a respective distance between the second feature vector of the legal proceeding and each of the other second feature vectors; and
for each of the other second features vectors that has a respective distance that meets a second threshold condition, providing, as training data, each of the other second features vectors that has the respective distance that meets the second threshold condition, to a machine learning algorithm, each of the other second features vectors that has the respective distance that meets the second threshold condition being labeled with its respective confusion score,
wherein the machine learning algorithm generates the machine learning model based on the training data.

7. The method of claim 2, wherein the first features are based on at least one of:
a measure of distance between the first trademark and the second trademark;
a number of similar characters in the first trademark and the second trademark;
an average number of characters in both the first trademark and the second trademark;
a number of similar characters at a predetermined position of the first trademark and the second trademark;
a number of consonants in each of the first trademark and the second trademark;
a number of vowels in each of the first trademark and the second trademark;
a number of special characters in each of the first trademark and the second trademark;
an average number of words in each of the first trademark and the second trademark;
a number of characters that match between the first trademark and the second trademark; or
a value indicative of whether a first portion of the first trademark is included in the second trademark.

8. The method of claim 1, wherein the attribute comprises at least one of:
a name of the first trademark and the second trademark;
a design of the first trademark and the second trademark; or
a classification of at least one of a good or service of the first trademark and the second trademark.

9. A system for predicting trademark similarity, comprising:
at least one processor circuit; and
at least one memory that stores program code configured to be executed by the at least one processor circuit, the program code configured to, when executed by the at least one processor circuit, cause the system to:
receive a first trademark pair comprising an attribute of a first trademark and a corresponding attribute of a second trademark;
determine a level of similarity between the first trademark pair and respective second trademark pairs included in respective legal proceedings maintained in a database, each of the respective legal proceedings pertaining to whether a likelihood of confusion exists between its respective second trademark pair;
select, from the database, a subset of legal proceedings from the legal proceedings, each legal proceeding of the subset including at least one respective second trademark pair that has the level of similarity with the first trademark pair that meets a threshold condition;
generate a first feature vector based on each legal proceeding of the subset of legal proceedings;
provide the first feature vector as an input to a machine learning model that outputs a prediction score, based on the first feature vector, as to whether a subsequent legal proceeding would find a likelihood of confusion between the first trademark and the second trademark; and
provide the prediction score to a user interface.

10. The system of claim 9, wherein the program code, when executed by the at least one processor circuit, is configured to cause the system to determine the level of similarity by:
generating a second feature vector based on first features of the first trademark pair;
for each legal proceeding of the legal proceedings, generating a third feature vector based on second features of a respective trademark pair to which the legal proceeding of the legal proceedings pertains; and
determining a respective distance between the second feature vector and each of the third feature vectors, the respective distance corresponding to a respective level of similarity between the first trademark pair and the respective trademark pair.

11. The system of claim 10, wherein the respective distance between the second feature vector and each of the third feature vectors is based on a similarity metric between the second feature vector and a respective third feature vector of the third feature vectors.

12. The system of claim 9, wherein each legal proceeding of the subset of legal proceedings is associated with at least one confusion score indicative of a likelihood of confusion between the at least one respective second trademark pair.

13. The system of claim 12, wherein the first feature vector comprises at least one of: for each legal proceeding of the subset of legal proceedings:
a first feature corresponding to the confusion score associated with the at least one respective second trademark pair of the legal proceeding;
a second feature corresponding to the level of similarity between the first trademark pair and the respective second trademark pair of the legal proceeding; or
a third feature corresponding to a similarity metric between the at least one respective second trademark pair of the legal proceeding.

14. The system of claim 9, wherein each legal proceeding of the plurality of legal proceedings is associated with at least one confusion score indicative of a likelihood of confusion between the at least one respective second trademark pair, and wherein the machine learning model is generated by:
for each legal proceeding of the plurality of legal proceedings:
generating a second feature vector based on a respective trademark pair to which the legal proceeding pertains;
for each legal proceeding of the plurality of legal proceedings:
determining a respective distance between the second feature vector of the legal proceeding and each of the other second feature vectors; and
for each of the other second features vectors that has a respective distance that meets a second threshold condition, providing, as training data, each of the other second features vectors that has the respective distance that meets the second threshold condition, to a machine learning algorithm, each of the other second features vectors that has the respective distance that meets the second threshold condition being labeled with its respective confusion score,
wherein the machine learning algorithm generates the machine learning model based on the training data.

15. The system of claim 10, wherein the first features are based on at least one of:
a measure of distance between the first trademark and the second trademark;
a number of similar characters in the first trademark and the second trademark;
an average number of characters in both the first trademark and the second trademark;
a number of similar characters at a predetermined position of the first trademark and the second trademark;
a number of consonants in each of the first trademark and the second trademark;
a number of vowels in each of the first trademark and the second trademark;
a number of special characters in each of the first trademark and the second trademark;
an average number of words in each of the first trademark and the second trademark;
a number of characters that match between the first trademark and the second trademark; or
a value indicative of whether a first portion of the first trademark is included in the second trademark.

16. The system of claim 9, wherein the attribute comprises at least one of:
a name of the first trademark and the second trademark;
a design of the first trademark and the second trademark; or
a classification of at least one of a good or service of the first trademark and the second trademark.

17. A computer-readable storage medium having program instructions recorded thereon that, when executed by at least one processor, perform a method for predicting trademark similarity comprising:
receiving a first trademark pair comprising an attribute of a first trademark and a corresponding attribute of a second trademark;
determining a level of similarity between the first trademark pair and respective second trademark pairs included in respective legal proceedings maintained in a database, each of the respective legal proceedings pertaining to whether a likelihood of confusion exists between its respective second trademark pair;
selecting, from the database, a subset of legal proceedings from the legal proceedings, each legal proceeding of the subset including at least one respective second trademark pair that has the level of similarity with the first trademark pair that meets a threshold condition;
generating a first feature vector based on each legal proceeding of the subset of legal proceedings;
providing the first feature vector as an input to a machine learning model that outputs a prediction score, based on the first feature vector, as to whether a subsequent legal proceeding would find a likelihood of confusion between the first trademark and the second trademark; and
providing the prediction score to a user interface.

18. The computer-readable storage medium of claim 17, wherein determining the level of similarity comprises:
generating a second feature vector based on first features of the first trademark pair;
for each legal proceeding of the legal proceedings, generating a third feature vector based on second features of a respective trademark pair to which the legal proceeding of the legal proceedings pertains; and
determining a respective distance between the second feature vector and each of the third feature vectors, the respective distance corresponding to a respective level of similarity between the first trademark pair and the respective trademark pair.

19. The computer-readable storage medium of claim 18, wherein the respective distance between the second feature vector and each of the third feature vectors is based on a similarity metric between the second feature vector and a respective third feature vector of the third feature vectors.

20. The computer-readable storage medium of claim 17, wherein each legal proceeding of the subset of legal proceedings is associated with at least one confusion score indicative of a likelihood of confusion between the at least one respective second trademark pair.
